(19) United States
(12) Patent Application Publication
(10) Pub. No.: US 2025/0021842 A1
(43) Pub. Date: Jan. 16, 2025

(54) MONITORING GENERATIVE MODEL QUALITY

(71) Applicant: Google LLC, Mountain View, CA (US)

(72) Inventors: Alon Shlomo Bernstein, Monte Sereno, CA (US); Sanjeev Dhanda, San Francisco, CA (US)

(21) Appl. No.: 18/351,929

(22) Filed: Jul. 13, 2023

(51) Int. Cl. G06N 5/043; G06N 5/02

(52) U.S. Cl. CPC G06N 5/043; G06N 5/02

(57) ABSTRACT

A system is disclosed that uses expert systems to monitor and evaluate quality in a large language model. The system can include a prompt library that associates prompts with areas of expertise. The system selects prompts from the library and evaluates first responses generated by a large language model for the set of prompts against second responses generated by a modified version of the large language model to the set of prompts. The evaluation uses expert systems associated with the areas of expertise for the set of prompts. If the system determines that the evaluation indicates a degradation criterion is met, the system may take remedial action. The system provides an effective way to evaluate and prevent the use of modified language models that do not meet the required standards.

### BACKGROUND

Large language models (LLMs) are machine-learning models trained to generate a response (estimate the probability of a sequence of tokens, including words and/or emoji) in response to a prompt (an input). Such large language models have a high number of parameters (e.g., billions, hundreds of billions) and are commonly based on a transformer architecture. These models can generate realistic text or image responses to a prompt and can generate entirely new content, referred to as creative content.

### SUMMARY

Disclosed implementations relate to a system for using expert systems to monitor the quality of responses generated by a large language model in a generative AI system. In particular, implementations use one, two, or more expert systems to evaluate responses generated by the large language model to queries. Expert systems are systems (including other models) that have high accuracy in a particular area. The expert systems used in evaluating the large language model may each represent a different area. An expert system for a first area (e.g., facts, such as a knowledge engine) can be used to evaluate responses generated for prompts that relate to the first area. Another expert system for a second area (e.g., solving mathematical equations) may be used to evaluate responses generated for prompts that relate to the second area. Likewise, a third expert system for a third area (e.g., translation) may be used to evaluate responses generated for prompts that relate to the third area, etc. An area can also be referred to as a vertical or area of expertise. Implementations may include one such system, two such systems, etc. Each expert system used to evaluate the model can have a set of prompts that relate to the area of expertise of an expert system. Some prompts can be evaluated by more than one expert system. The prompts and evaluations can be used in various ways.

In some implementations, the evaluations can be used in benchmarking. For example, a system may evaluate responses generated by a large language model to a set of prompts before fine-tuning/training and evaluate responses generated by the large language model to the same set of prompts after fine-tuning/training. The system can compare the evaluations to identify any prompts where the quality of the responses have improved, stayed the same, or degraded. If too many have degraded, the updated model may not be considered ready for production because the updates have harmed the model quality. Even if the overall model quality has not degraded, analysis of the prompts/responses that failed may identify an area of the model that could benefit from further updating/training/fine tuning.

In some implementations, the evaluations can be used in high-water marking. For example, a system may have a set of prompts for which the large language model must generate an acceptable response. Put another way, some prompts may be identified as quality backstop prompts. Responses generated by a modified large language model (e.g., modified by training/fine-tuning) for one of these prompts must be deemed by the expert system to be acceptable. Failure to generate an acceptable response to a backstop prompt indicates the fine-tuning/training (the modification) has adversely affected the large language model and the updated model may not be considered ready for production. Such a decision point can be a decision point in quality assurance testing before making the updated large language model available for production use.

In some implementations, the evaluations can be used in monitoring. For example, a response/responses generated for prompts spiking in popularity (viral prompts) may be evaluated to determine whether the responses are of low quality so that action can be taken to prevent the further providing of such low quality responses. As another example, the system may monitor model responses to determine whether there are any trends in low quality responses. Such monitoring may proactively identify areas where the model may benefit from additional training, which will improve the performance of the model.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example system in which improved techniques described herein may be implemented.

FIG. 2 is a diagram that illustrates an example generative AI system and an example model evaluation system, according to disclosed implementations.

FIG. 3 is a diagram that illustrates an example method for using expert systems for benchmarking a modified large language model, according to disclosed implementations.

FIG. 4 is a diagram that illustrates an example method for using expert systems for benchmarking a modified large language model, according to disclosed implementations.

FIG. 5 is a diagram that illustrates an example method for using expert systems for high-water marking a modified large language model, according to disclosed implementations.

FIG. 6 is a diagram that illustrates an example method for identifying low-quality trends produced by a large language model, according to disclosed implementations.

FIG. 7 is a diagram that illustrates an example method for identifying viral low-quality responses produced by a large language model, according to disclosed implementations.

FIG. 8 is a diagram that illustrates an example of a distributed computer device that can be used to implement the described techniques.

### DETAILED DESCRIPTION

Implementations relate to a system for monitoring and maintaining quality in a generative AI system (e.g., based on a large language model) that can respond to open-ended prompts. Such generative systems can offer responses to a wide variety of prompts. Generally, the models are expected to generate responses to include factual information, but the generative/creative nature of the large language models can cause hallucinations in the responses. Put another way, a problem with large language models used in generative AI systems is that the models are generalist models, covering a vast landscape of topics and are expected to be accurate (factual) in the responses but also creative. But achieving creative and highly accurate responses across a vast landscape of topics to some prompts can be difficult to achieve. Conventionally, such large language models cover a vast landscape of topics adequately, but have problems with accuracy (quality) in the responses. Such models can be trained and/or fine-tuned to help reduce hallucinations (factually incorrect statements) in one area, but such training and fine-tuning often has unintended consequences in another area. For example, training a model to solve equations more accurately may cause a drop in the quality of a response that includes a translation. Accordingly, maintaining model quality across the vast landscape of topics is a technically difficult problem.

To address the technical problem of how to monitor and maintain quality in a generative conversation system, implementations employ expert systems. An expert system is any system that operates with high accuracy in a specific area. An example of an expert system is a knowledge engine. A knowledge engine is a system that includes a graph database of entities and an understanding engine. The graph database stores facts about entities, as entity attributes and/or as relationships between entities. An understanding engine is configured to extract entities, entity attributes, and entity relationships from natural language documents (web pages, PDFs, presentations, spreadsheets, media (audio/video) files, etc., using natural language processing techniques. Typically, the extracted information is used to update the graph, so the graph contains highly accurate information about entities, i.e., facts. Such knowledge engines have been in use for many years and operate (e.g., identifying factual information related to entities) with high accuracy. This is one example of an expert system, but there are many similar systems used to identify and verify knowledge (facts) in other areas. For example, there are existing expert systems related to medical transcription (a medical document engine), translations (a translation engine), solving mathematical equations (a math engine), a system that analyzes failures (e.g., software failures) to determine a root cause (a failure analysis engine), a search engine (for verifying factual statements), a process that compares factual statements with a structured entity repository, such as Wikipedia, etc. In some implementations a version of the large language model may be used as an expert system for evaluating aspects of a response. Such an expert system may be helpful in evaluating the creativity of or creative aspects of a response. For example, a version of the model can be asked to evaluate how well a response generated for a particular prompt related to poetry rhymes or adheres to a particular format. As another example, a version of the model can be asked to evaluate whether a response includes a creative twist or to evaluate a level of creativity in a response.

Implementations use expert systems to evaluate a prompt and response generated for the prompt by a generative conversation system (i.e., a prompt-response pair). As used herein, a prompt can include prompt context where appropriate. Prompt context can include prior prompts and generated responses (or portions thereof), if they exist. Such context is often referred to as occurring in a session. A new session starts with no prompt context. Each prompt and response can be referred to as a turn within the session. The context enables the large language model (or an expert system) to resolve pronouns in a prompt. For example, the user may have previously provided a prompt of “who was George Washington's wife” and received a response of “Martha Washington” and a current prompt may be “how many children did they have”. The prompt context of the prior prompt and its response enables the large language model and/or a knowledge engine to resolve “they” in the current prompt to Martha and George Washington. Prompt context can also be used to focus a response, e.g., providing material from which to generate the response. The prompt context can be limited, e.g., to a predetermined number of characters, a predetermined number of turns in the session, to a predetermined amount of memory, etc., depending on the implementation of the generative AI system.

The prompt and response may be translated into an input format expected by the expert system. In other words, a prompt and response can be translated into a first input format configured for processing by a first expert system and also into a second input format configured for processing by a second expert system. This enables the expert systems to operate without change. For example, a prompt may be translated to, or treated as, a query for evaluation by the knowledge engine and the response to the prompt may be translated to, or treated as, a candidate document to be scored by the knowledge engine in response to the query. A response can also be treated by the knowledge engine as a document to be indexed. A score assigned to a prompt/response can represent topicality (relevance), and/or factuality. Similarly, a prompt may be translated into an input format expected by a mathematical expert system to produce an output that can then be compared to the response generated by the generative conversational system to determine a score representing similarity, topicality, and/or correctness.

The evaluations can be used in a variety of implementations. In one implementation, the expert systems can be used in benchmarking to identify any overall degradation in model quality due to model modifications (e.g., from training/fine-tuning). In one implementation, the evaluations can be used in high-water marking to identify a specific degradation in model quality due to model modifications. In one implementation, the evaluations can be used to monitor model quality in a production environment. For example, in one implementation, the evaluations can be used to identify viral prompt topics/patterns where response quality is inadequate. As another example, the evaluations can be used to monitor for longer-term trends (a topic, prompt pattern, etc.) for which the model could use further modification. Implementations can include systems which use the evaluations in any combination of the above examples.

A technical advantage of disclosed implementations is that unintended consequences of modifying a large language model can be identified and addressed before rolling the unintended consequences to production. Another technical advantage of disclosed implementations is that areas of model weakness can be proactively identified. Avoiding unintended consequences maintains model quality and proactively identifying model weakness improves model quality.

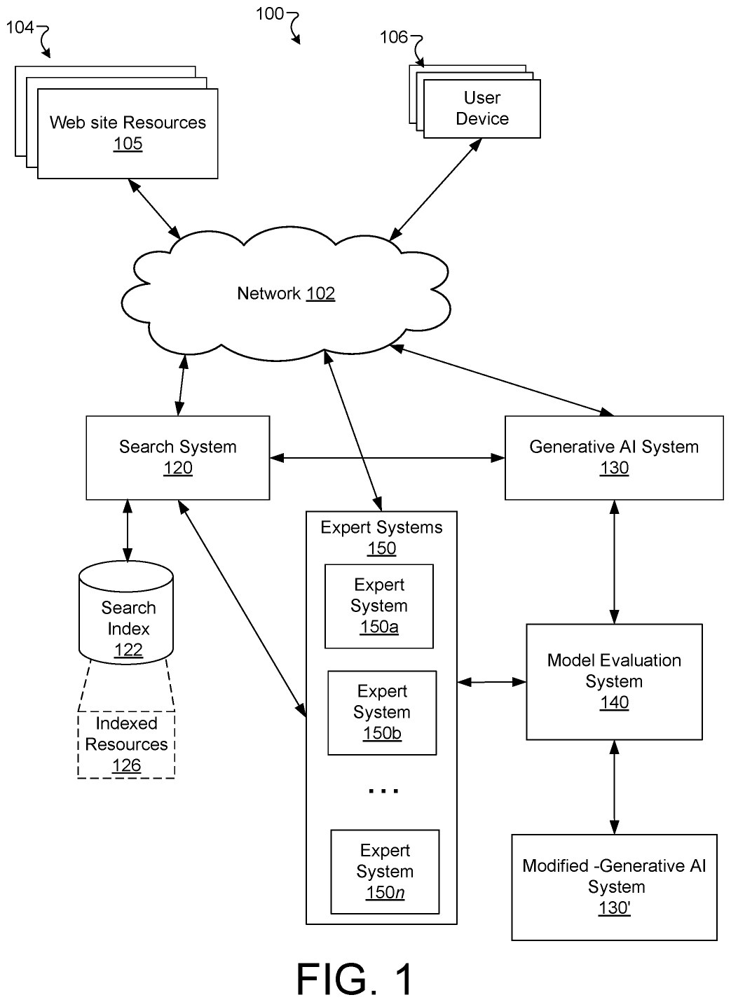

FIG. 1 depicts an example environment 100 in which users can interact with one or more generative AI large language models. The environment 100 includes a model evaluation system that uses expert systems to monitor and improve model quality of a generative AI system. In the example of FIG. 1, the generative AI large language model is supported by an Internet search engine to help the model improve factuality, but use of a search engine is optional. Implementations are not limited to large language models supported by a search engine.

With continued reference to FIG. 1, the example environment 100 includes a generative AI system 130, a model evaluation system 140, one or more expert systems 150, search system 120, network 102, and user devices 106. Some implementations can also include a search system 120, which indexes web site resources 105. The network 102, can be a local area network (LAN or Wi-Fi network), wide area network (WAN), the Internet, or a combination thereof. The network 102 connects web sites 104, user devices 106, the generative AI system 130, the expert systems 150, and the search system 120. In some examples, the network 102 can be accessed over a wired and/or a wireless communications link. For example, mobile computing devices, such as smartphones can utilize a cellular network to access the network. The environment 100 may include millions of web sites 104 and user devices 106. In some implementations, the generative AI system 130 may be co-located with the search system 120. In other words, in some implementations the generative AI system 130 and the search system 120 may be operated at a same server, which may be a distributed server. In some implementations one or more of the expert systems 150 can be co-located with the search system 120. In some implementations, one or more of the expert systems 150 can be co-located with the generative AI system 130. In some implementations, the model evaluation system 140 can be co-located with the generative AI system 130. In some implementations, the model evaluation system 140 can be co-located with the search system 120. In other words, any combination of the generative AI system 130, the model evaluation system 140, the expert systems 150, and the search system 120 can be co-located (operated by a same server, including a distributed server environment). The generative AI system 130, model evaluation system 140, expert systems 150, and/or the search system 120 may be communicatively coupled. In other words, whether co-located or not, the generative AI system 130, model evaluation system 140, expert systems 150, search system 120 (if included), may be configured for communication with each other via one or more application programming interfaces.

The model evaluation system 140 is a system configured to use one or more expert systems 150 to evaluate the responses generated by the generative AI system 130 (including modified generative AI system 130′). The expert systems 150 may include any number (one, two, three, . . . , n) of expert systems. One or more of the expert systems 150, e.g., expert system 150a, expert system 150b, and/or expert system 150n, may be any existing system configured to identify and/or evaluate information for a specific area of expertise (i.e., vertical) with high accuracy. High accuracy is easier to attain in a specific area of expertise. A knowledge engine is one example of an expert system. A math engine is another example of an expert system. A math engine may be configured to solve a given mathematical or scientific question, showing step-by-step reasoning. A translation engine is another example of an expert system. A translation engine is configured to translate text from one language to another. These expert systems are configured to perform well in their specific area of expertise and may have uses outside of use by the model evaluation system 140. For example, a knowledge engine is often used by a search system, such as search system 120, to identify entities and entity facts in resources 105, identify discrepancies between facts extracted from resources 105 and the entity repository (e.g., graph database), and/or to evaluate the relevance and/or topicality of a resource 105 to a query. As another example, a translation engine is often used in translation applications (e.g., independently of the search system 120 and/or the generative AI system 130).

In some implementations, the model evaluation system 140 may be configured to evaluate a modified large language model, e.g., a model used in modified generative AI system 130′. To evaluate a modified model, the model evaluation system 140 may use a prompt collection, or in other words a library of prompts. The prompt collection may represent a variety of prompts used for evaluation. The prompt collection can associate each prompt with one or more areas of expertise. In other words, each prompt in the prompt collection may be associated with at least one expert system. For example, some prompts may represent translation queries, some prompts may represent factual queries, some prompts may represent mathematical or scientific problems, etc. Some prompt libraries may include historical scoring data for some or all of the prompts, as discussed herein.

The modified generative AI system 130′ may represent a system that uses an updated version of the model used by generative AI system 130. The generative AI system 130 may be a model running in inference mode, e.g., a model executing in a production environment. Thus, the large language model of the generative AI system 130 may be used to respond to prompts from user devices 106. To improve the model of the generative AI system 130, further training and/or fine-tuning may be used. This additional training may be performed in a development environment, e.g., as part of modified generative AI system 130′. In the development environment, training can occur “offline” (i.e., not in a production environment). Thus, the modified generative AI system 130′ does not respond to queries from users generally, but can be accessible to user devices 106 or processes (e.g., as part of model evaluation system 140) for training and evaluation purposes. Once training and/or fine-tuning of the modified model is complete, the model of the modified generative AI system 130′ may be moved to (rolled out to) the production environment, e.g., at generative AI system 130.

In some implementations, the model evaluation system 140 may be configured to monitor a large language model that is used in a production environment, e.g., in generative AI system 130. To monitor model quality the model evaluation system 140 may be configured to access a repository of prompt-response pairs. The repository of prompt-response pairs may be a collection of responses generated by the large language model (e.g., of generative AI system 130 or modified generative AI system 130′) in response to prompts, each response being paired with the prompt for which it was generated. The prompt of a prompt-response pair may include prompt context. The repository of prompt-response pairs may also be referred to as a model log. Such model logs can be produced by generative AI system 130 and/or modified generative AI system 130′.

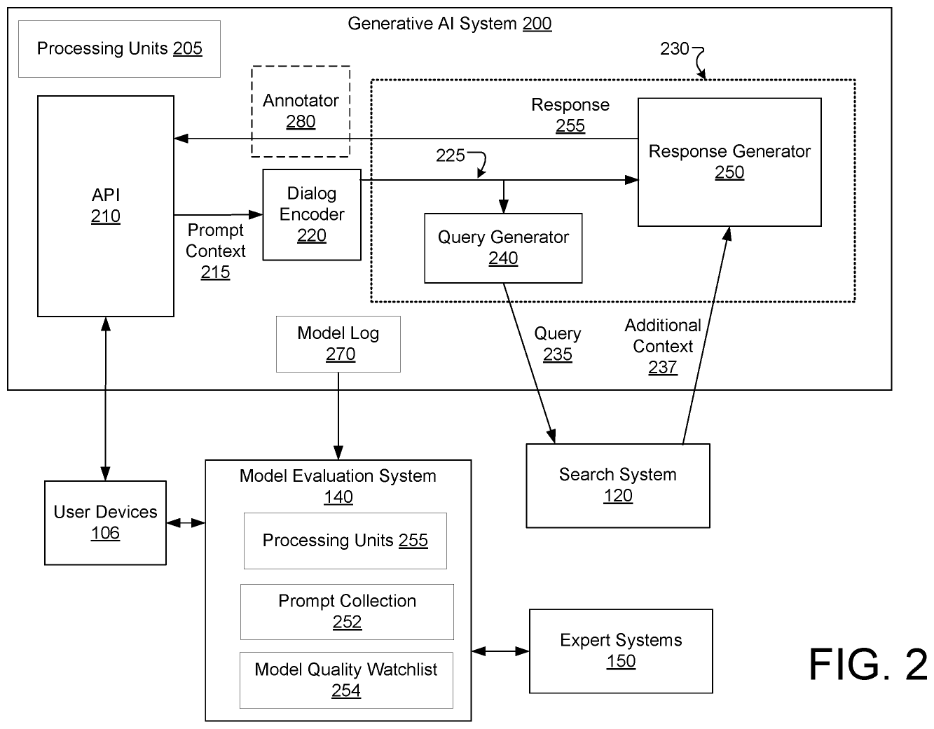

The generative AI system 130 and modified generative AI system 130′ can be any system that supports a large language model. The large language model may be configured for conversation, i.e., be a model configured to interact with users on a wide variety of topics. An example generative AI system and an example model evaluation system 140 are described in more detail in FIG. 2.

In some implementations, the generative AI system 130 may be configured to utilize a search system 120 to improve factuality in the generated responses. In such an implementation the generative AI system 130 may be configured to send a query to the search system 120. The search system 120 provides search services. In some examples, to facilitate searching of resources 105, the search system 120 identifies the resources 105 by crawling and indexing the resources 105 provided on web sites 104. Data about the resources 105 can be indexed. The indexed and, optionally, cached copies of the resources 105 are stored in a search index 122, e.g., as indexed resources 126.

In some implementations, the search system 120 may include and/or may be configured to communicate with and utilize one or more expert systems 150 as part of indexing or responding to queries. For example, the search system 120 may include or may be configured to use a knowledge engine (e.g., expert system 150a). The knowledge engine may identify entities in resources 105 at indexing time and score the resource 105 for the identified entities. For example, the knowledge engine may give the resource a topicality score for an entity that represents how relevant (topical) the resource is for the entity. In some implementations, the knowledge engine may determine whether a fact (entity attribute or entity relationship) in the document differs from a fact represented in the database of entities. In some implementations, the search system 120 may associate an entity with a resource based on the topicality score. In response to a query, the search system 120 may use the knowledge engine to determine how topical a document is to a factual query. A factual query is a query that requests one or more facts about an entity. In some implementations, the search system 120 may include or may be configured to use other expert systems 150 (e.g., expert system 150a, expert system 150b, expert system 150n) in indexing documents and/or responding to queries.

In implementations where the generative AI system 130 uses the search system 120 to increase the accuracy of responses that include facts, the generative AI system 130 may communicate using an application programming interface (API) of the search engine of the search system 120. The search engine API may return search results in a way that is not formatted for display, but instead enables the generative AI system 130 to read, analyze, and further process the information in a search result (e.g., the resource address, the relevant text extracted from the content, the title, etc.). In addition, the search engine API may enable the generative AI system 130 to request properties of the returned search results, e.g., a particular number of search results, a particular minimum relevancy of search results, etc., for a query.

Environment 100 may also include user device 106. In some examples, a user device 106 is an electronic device that is under control of a user and is capable of requesting and receiving resources 105 over the network 102. Example user devices 106 include personal computers, mobile computing devices, e.g., smartphones, wearable computing devices, and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device, as are wearables and other smart devices such as smart TVs and smart speakers. A user device 106 typically includes a user application, e.g., a web browser, to facilitate the sending and receiving of data over the network 102.

The user devices 106 may include, among other things, a network interface, one or more processing units, memory, and a display interface. The network interface can include, for example, Ethernet adaptors, Token Ring adaptors, and the like, for converting electronic and/or optical signals received from the network to electronic form for use by the user device 106. The set of processing units includes one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

The user devices 106 may submit search queries to the search system 120 and/or prompts to the generative AI system 130. In some examples, a user device 106 can include one or more input devices. Example input devices can include a keyboard, a touchscreen, a mouse, a stylus, a camera, and/or a microphone. For example, a user can use a keyboard and/or touchscreen to type in a search query. As another example, a user can speak a search query, the user speech being captured through the microphone, and processed through speech recognition to provide the search query. As another example, a user may use a camera to capture an image that is sent to the search system 120 as a query and/or to the generative AI system 130 as part of a prompt.

In response to receiving a search query, the search system 120 processes the query and accesses the search index 122 to identify resources 105 that are relevant to the search query, e.g., have at least a minimum specified relevance score for the search query. The search system 120 identifies the resources 105, generates a search result page. The search system 120 returns the search result page to the query requestor. For a query submitted by a user device 106, the search result page is returned to the user device 106 for display, e.g., within a browser, on the user device 106.

In response to receiving a prompt, the generative AI system 130 processes the prompt (including any prompt context) and generates a response to the prompt using a large language model. The prompt is provided to the user by the user device 106 (e.g., displayed, played, or otherwise output). The user may provide another prompt to the generative AI system 130, e.g., in another turn of a communication session. The generative AI system 130 generates a response to this prompt and provides the response to the user device 106, etc.

FIG. 2 is a diagram that illustrates an example generative AI system 200, according to disclosed implementations. The generative AI system 200 can be an example of generative AI system 130 or modified generative AI system 130′. The generative AI system 200 is configured to generate responses to prompts. A prompt can be any input received from a user of the user device 106, e.g., via user interface 210. One or more of the components of the generative AI system 200 can be, or can include processors (e.g., processing units 205) configured to process instructions stored in a memory. Examples of such instructions as depicted in FIG. 2 include the user interface 210, the dialog encoder 220, and a large language model 230.

The user interface 210 is configured to receive prompts from the user device 106. In some implementations, user interface 210 receives the prompts over a network interface, i.e., over a network such as network 102 . . . . The user interface 210 can be configured to display a prompt input area. The prompt input area may take text as input. The prompt input area may take images as input. The prompt input area may take media (audio/video) files as input. The user interface 210 may also be configured to display the response 255 to a prompt. In some implementations, the user interface 210 may be part of (included in) another user interface. For example, the user interface 210 can be part of a search engine user interface, a browser tool or extension, a document extension or add in, a user interface for the model evaluation system 140, etc. The user interface 210 may be part of a web page, e.g., so that the user interface 210 is configured to provide the response 255 as part of a browser interface on the user device 106.

The user interface 210 may be configured to display a conversation or a portion of a conversation. A conversation includes the prompts and responses (prompt rounds) associated with a session. A session can be defined by a user, by a predetermined number of prompt rounds (a round being a prompt and its corresponding response), by a criteria (e.g., a predetermined topic/prompt may cause the generative AI system 200 to initiate a new session), etc. A conversation can be part of a prompt context 215. A prompt context 215 can thus include a current prompt and the prior prompt rounds. If no prior prompt rounds exist, the prompt context may include the current prompt. In some implementations, the prompt context 215 can include metadata. The metadata can include a number of prior prompt rounds. The metadata can include, with user permission, information about content displayed on a display of the user device 106. The metadata can include a topic and/or entity determined from the content displayed on the display. The metadata may include any information about the user device 106 and/or user preferences (with user permission) relevant to the prompt.

The generative AI system 200 may include dialog encoder 220. The dialog encoder 220 is configured to generate encoded dialog 225. The dialog encoder 220 may de-normalize the current prompt of the prompt context 215 in generating the encoded dialog 225. De-normalizing the current prompt replaces references to entities outside of the prompt with the entity. The reference could be to an entity mentioned in a prior prompt or prior response of the prompt context 215 (e.g., a prompt or response from a prior round). The reference could be to an entity in the metadata. For example, a prior prompt may be “Show me restaurants in Portland” and a current prompt may be “No, I mean Maine.” The dialog encoder 220 may be configured to change the current prompt to “show me restaurants in Portland Maine.” Likewise, if the current prompt is “show me restaurants in Portland” the dialog encoder 220 may be configured to disambiguate Portland based on metadata in the prompt context 215, e.g., an approximate location, a topic in the metadata, identification of an entity in the metadata (e.g., Acadia National Park in Maine or Mt. Hood in Oregon), etc. The dialog encoder 220 may also use prior prompt rounds for disambiguation. For example, “show me restaurants in Portland” may be disambiguated based on a prior response that mentions the Columbia River (e.g., in Oregon) or Boothbay Harbor (e.g., in Maine). In some implementations, the dialog encoder 220 may also vectorize the denormalized prompt context, i.e., convert the denormalized prompt context to vectors of real numbers (feature vectors). Thus, the encoded dialog 225 can be represented as feature vectors used as input for the large language model 230. In some implementations, the large language model 230 may vectorize the encoded dialog 225 (the denormalized prompt context).

The large language model 230 is an example of a large language model. The large language model 230 is trained to generate conversational responses to prompts (e.g., response 255) that have some level of creativity. In some implementations, the response can include an image. The image may be relevant to an entity in the prompt and/or the response. The image can be an image generated by the large language model 230. A response has some level of creativity when the response is not copied from a source and is conversational in nature. This makes the response 255 different from search results obtained in response to a search query. Search results include relevant text (snippets) taken directly from a source. Some search result pages include short answers. The short answers are conventionally taken from a search result or from an API of a service (e.g., such as weather data from weather.com). Some search result pages include a knowledge panel, with information taken from an entity repository, such as a knowledge graph. In each of these cases the information is traceable to a resource and not altered or only slightly altered. In contrast, the response 255 is not credited directly to any source (reference) because the response is synthesized by the large language model 230. The large language model 230 can provide responses for open-ended prompts, such as “write a poem about x” or “do you have an opinion on ice cream?”. Such prompts require a high level of creativity. The large language model 230 can also generate responses for complex questions (e.g., “what causes poverty?”), opinion questions (“is baseball better than cricket?”), etc. These responses may have a high level of creativity while including statements that can be verified (i.e., factual statements). Because a large language model, such as large language model 230, generates responses with some level of creativity, the responses can include factual information that is incorrect. Such incorrect factual information is referred to as a hallucination. The large language model 230 can be configured (trained/fine-tuned) to minimize hallucinations in one area (e.g., by modified generative AI system 130′), but doing so can degrade model quality in another area. Implementations help identify problematic training to prevent degradation in a production model (e.g., a model used in generative AI system 130).

In some implementations, the generative AI system 200 is configured to gather additional data to help the large language model 230 generate fewer hallucinations. For example, the large language model 230 may use a query generator 240 that generates one or more queries 235 based on the prompt context 215. The queries 235 are sent to the search system 120 to obtain resources that can be used as additional context 237 for a response generator 250. In implementations that use a query generator 240, the query generator 240 may be configured to generate a query 235 for every encoded dialog 225 or just for certain prompt contexts (e.g., prompts that request factual information). In some implementations, the query generator 240 may generate more than one query for an encoded dialog 225.

The search system 120 provides a search result for the query 235. In the context of the generative AI system 200, the search results may be used as additional context 237. The generative AI system 200 may be configured to transform or modify the search results returned by the search system 120 to make the information suitable as an input for the response generator 250 using known or later developed techniques.

The response generator 250 may have a similar architecture as other conversational large language models (e.g., GLaM, LaMDA, PaLM, GPT-3, ChatGPT, etc.). The response generator 250 is capable of generating responses with high creativity, for example in response to open-ended prompts (e.g., “give me five first date ideas”) and prompts that lack any factual context (e.g., “how are you?”). In some implementations, the response generator 250 generates responses to factual questions informed by the additional context 237, by “memorized” facts that are learned from the training data, and by potential hallucinations that might be related to the conversation context or the stochasticity of the generation process. The response generator 250 can also generate responses with one or more factual statements. The additional context 237, if used, is an additional input to the response generator 250 and can represent relevant text from supporting resources determined to be relevant to the query 235 to reduce hallucinations in any factual statements in the response 255. In other words, in some implementations, the response generator 250 may take the encoded dialog 225 and additional context 237 as input. The additional context 237 may represent relevant text from resources determined to be relevant to the query 235. In some implementations, the response generator 250 can be trained (refined, or fine-tuned) to learn when and how to use the additional context 237 in generating a response 255 to a prompt context 215. The further training may be evaluated using the model evaluation system 140 and the expert systems 150 as described herein.

In some implementations, the generative AI system 130 may include an annotator 280. The annotator 280 may be configured to add information to the response that enables the user to check/corroborate the response 255 generated by the response generator 250 using known or later developed techniques.

In some implementations, the generative AI system 130 may generate model log 270. Model log 270 may include records that capture a turn in a conversation. A record in the model log 270 can include at least a prompt (e.g., prompt context 215) and the response 255 generated for the prompt. The prompt and the response generated for the response are referred to as a prompt-response pair. Thus, model log 270 can also be referred to as a prompt-response repository. Certain data from a prompt-response pair may be treated in one or more ways before it is stored in the model log 270 so that personally identifiable information is removed. The model log 270 may be used by model evaluation system 140 to identify areas in which the large language model 230 needs intervention, including additional training or avoidance of unsuitable responses. For example, the model log 270 may be used by the model evaluation system 140 to identify viral prompts that result in responses that include unsuitable hallucinations. Virality manifests as an unexpected spike in receipt of a particular prompt over a short window of time. This short window of time can be measured in minutes, hours, or a few days. In some implementations, the generative AI system 200 may identify viral prompts and the model evaluation system 140 may evaluate the responses generated for the prompts. In response to determining that responses for a viral prompt are undesirable (e.g., include hallucinations or are otherwise of poor quality, as determined by the expert systems 150), the model evaluation system 140 may initiate remedial action. The remedial action can include actions such as preventing the large language model 230 from responding to such prompts, identifying the prompt as an area for further refinements of the large language model 230, sending notifications to an operator of the generative AI system 200, adding the prompt to a prompt collection, such as prompt collection 252, etc.

The model evaluation system 140 can be configured to identify a trend using the model log 270. A trend represents a topic or area for which the large language model 230 fails to provide adequate responses. The adequacy of a response for any particular topic or area is determined by the expert systems 150. For example, the model evaluation system 140 may evaluate prompt-response pairs from the model log 270. The selection of prompt-response pairs from the model log 270 can be done randomly. The selection can be done from prompt-response pairs that were received within a most recent window of time. The window of time may represent hours, days, weeks, etc. In other words, for trend detection the window of time can be longer than a window of time used to identify viral prompts. In some implementations, the generative AI system 200 may select every nth prompt-response pair for evaluation by the model evaluation system 140. The model evaluation system 140 may use the expert systems 150 to determine whether any of the prompt-response pairs include a low quality response. A low quality response is a response that has a score that fails to meet a quality threshold. The score is a score determined using one or more of the expert systems 150, as disclosed herein.

If any of the prompt-response pairs do have a low quality response, the model evaluation system 140 may add the response to a model quality watchlist 254. The model quality watchlist 254 is a data store of prompt-response pairs that the model evaluation system 140 can analyze to determine a trend. The model quality watchlist 254 represents prompts for which a response generated for the prompt has been evaluated using an expert system and identified as having insufficient quality. In some implementations, the model quality watchlist 254 may also represent prompts and responses that a user has identified as of poor quality.

In determining a trend, the model evaluation system 140 may cluster prompts, e.g., by topic, by prompt format, etc. This may generate topic clusters or format clusters, etc., each cluster having a number of members (or in other words, each cluster may have a quantity of members). The model evaluation system 140 may cluster prompts in multiple different ways for the analysis. If there is a sufficient quantity of (a predetermined number of) prompts in any cluster, the model evaluation system 140 may determine that the cluster represents a trend of responses with low quality. The model evaluation system 140 may take remedial action with respect to identification of the trend. For example, remedial action may be reporting the trend to an operator of the generative AI system 200, which suggests that the large language model 230 could benefit from further training/fine-tuning in the trend area. In some implementations, the remedial action may be adding the prompt to a prompt collection, such as prompt collection 252. In some implementations, the model quality watchlist 254 may include a time decay. In other words, prompt-response pairs that are too old may not be included in the analysis or may be given a low weight in the analysis. This may occur because such pairs are deleted from the model quality watchlist 254 or because older pairs are weighted by age, e.g., pairs that are over x days old count as a half, over y days old as a third, over z days old as a tenth, etc.

The model evaluation system 140 may be used to monitor modifications made to the large language model 230 through further training/fine-tuning to ensure that the modifications do not degrade the quality of the modified model. Model quality is measured by scores derived from application of one or more of the expert systems 150 to responses generated for prompts. The scores can reflect things like veracity (factuality), topicality, relevance, similarity with a response generated by an expert system, etc. To evaluate modification made to the large language model 230, the model evaluation system 140 may include a prompt collection 252. The prompt collection 252 may also be referred to as a prompt library. The prompt collection 252 may assign prompts to an area of expertise. Each area of expertise corresponds to one of the expert systems 150. A prompt can be associated with more than one area of expertise. In some implementations, the large language model 230 may be used to generate prompts for the prompt collection 252. For example, if a particular topic is identified as needing additional training, before performing that additional training the large language model (e.g., the query generator 240) can be used to generate prompts related to that topic. This enables the system to have a large number of prompts for benchmarking the additional training.

In some implementations, the prompt collection 252 may also associate a scoring history with a prompt. The prompt collection 252 may associate a prompt and area of expertise with a scoring history, e.g., so that each area of expertise associated with a prompt may also have a scoring history. The scoring history represents at least one score obtained for a response to the prompt from a prior version of the large language model 230. This prior version can be a version of the model that is currently running in a production environment. The model evaluation system 140 can use the score from the scoring history in a comparison with a score of a response to the prompt generated by a modified large language model 230. In some implementations, rather than storing a scoring history the model evaluation system 140 may obtain a response from the large language model 230 running in a production environment and score that response, thus obtaining the “prior” score from the unmodified version of the model at the monitoring time. The difference between the prior score (e.g., production score or unmodified model score) and the current score (e.g., the score for the modified model's response generated for the prompt) can be used in benchmark testing and/or high-water mark testing. In some implementations, the prompt collection 252 may include more than one prior score for a prompt. In such an implementation each prior score may represent a different period of time. Thus, for example, as a prompt is used in evaluation the prompt collection 252 may record how the score for the response changes over time.

In benchmark testing, the model evaluation system 140 may select a set of prompts from the prompt collection 252, obtain responses for the prompts in the set, use the expert systems 150 to score the responses (e.g., obtaining current scores for the responses), compare the current scores with prior scores and analyze the differences. In benchmarking, the analysis may be a comparison over the population, i.e., over the prompts in the set of prompts. Thus, in benchmark testing the scores as a whole are considered, which allows a conclusion of no degradation in model quality even when a score for a first prompt decreases while the score for a second prompt increases. In other words, in benchmarking the model evaluation system 140 may use a degradation criterion (or criteria) for individual prompt scores in aggregate. If the benchmark testing indicates the modified model fails the benchmark (e.g., the degradation criterion is met) the modified model may be prevented from being put into a production environment because the modification represents model degradation.

In high-water mark testing, the model evaluation system 140 may evaluate prompts identified as quality backstop prompts in the prompt collection 252. A quality backstop prompt is a prompt for which the large language model 230 must generate an acceptable response. In other words, if the modified model does not generate a response with acceptable quality (as determined by means of a score calculated using at least one of the expert systems 150), the high-water mark testing fails. Such prompts may include prompts curated by operators of the generative AI system 200. Such prompts may represent prompts in sensitive or important areas. Such prompts may also represent prompts that have demonstrated historical stability. For example, the model evaluation system 140 may use the prompt collection 252 to identify prompts with a scoring history in an area of expertise where the model has historically (e.g., over the last six months, over the last year) generated a response of adequate quality. In other words, an expert system has consistently shown that responses generated for the prompt have prior scores that meet a quality threshold. After a sufficient time (e.g., months, a year, etc.) the prompt may be considered a quality backstop prompt. In some implementations, quality backstop prompts may be identified as such in the 252 by a flag. In some implementations, the model evaluation system 140 may analyze the scoring history of prompts in the prompt collection 252 to identify prompts qualifying as quality backstop prompts based on historical stability. In some implementations, the model evaluation system 140 may use a combination of flags and analysis to identify quality backstop prompts. In some implementations, once a quality backstop prompt has been identified, it can be used for seeding similar prompts, which may also be considered quality backstop prompts. For example, the large language model may be asked to generate prompts similar to the quality backstop prompt. These similar prompts can be used to ensure consistent responses from the updated model.

The model evaluation system 140 may use a set (some or all) of the quality backstop prompts in the high-water mark testing. For such prompts, the model evaluation system 140 may score a response generated by the modified large language model 230 for the prompt using one or more of the expert systems 150. In this case a model degradation criterion is failure of the score to meet a quality threshold. In other words, if any scores fail to meet the quality threshold the modified model is considered to be of lower quality and the model evaluation system 140 may initiate remedial action. Such remedial action may include preventing the model from being put into a production environment. This prevents model quality degradation in production based on unintended consequences of the training. Remedial action can also include reporting of the prompt that failed the quality threshold to an operator of the generative AI system 200. The operator can then determine whether or not further training of the large language model 230 is needed or determine how to change the training to avoid the identified degradation, etc. Any quality backstop prompt that fails the degradation criterion may be included in such a report.

Further to the descriptions above, a user may be provided with controls allowing the user to make an election as to both if and when systems, programs, or features described herein may enable collection of user information (e.g., information about a conversation with the generative AI system, information about a user's preferences, or a user's current location), and if the user is sent content or communications from a server. In addition, certain data may be treated in one or more ways before it is stored or used, e.g., in the model logs, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

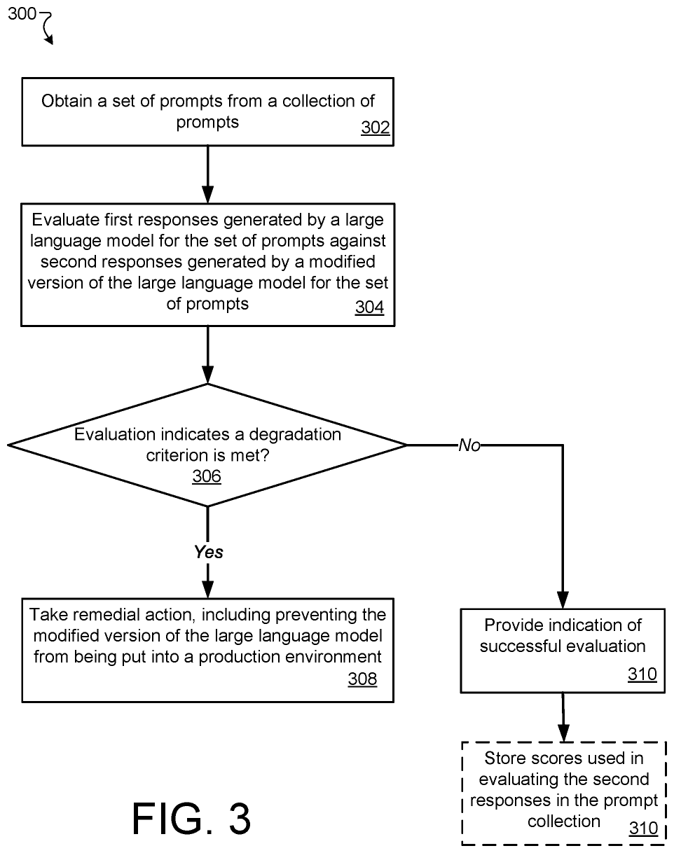

FIG. 3 is a diagram that illustrates an example method 300 for using expert systems for benchmarking a modified large language model, according to disclosed implementations. Method 300 may be executed in an environment, such as environment 100 of FIG. 1. The method 300 enables evaluation of the modified model against a prior version of the model, e.g., a version running in a production environment, a version that passed previous benchmarks but has not yet been put into production, etc. The prior version of the model is considered a current version, or a first version, or an unmodified version. The modified version of the model may represent additional training/fine-tuning performed on the model. In some implementations, the method steps may be executed by a system, such as model evaluation system 140. In some implementations, the method steps may be executed by a system that includes the model evaluation system 140 and one or more expert systems 150. In some implementations, the method steps may be executed by a system that includes the model evaluation system 140, one or more expert systems 150, and the generative AI system 130′ of FIG. 1. In some implementations, the method steps may be executed by a system that includes the model evaluation system 140, one or more expert systems 150, the generative AI system 130 and/or the generative AI system 130′ of FIG. 1.

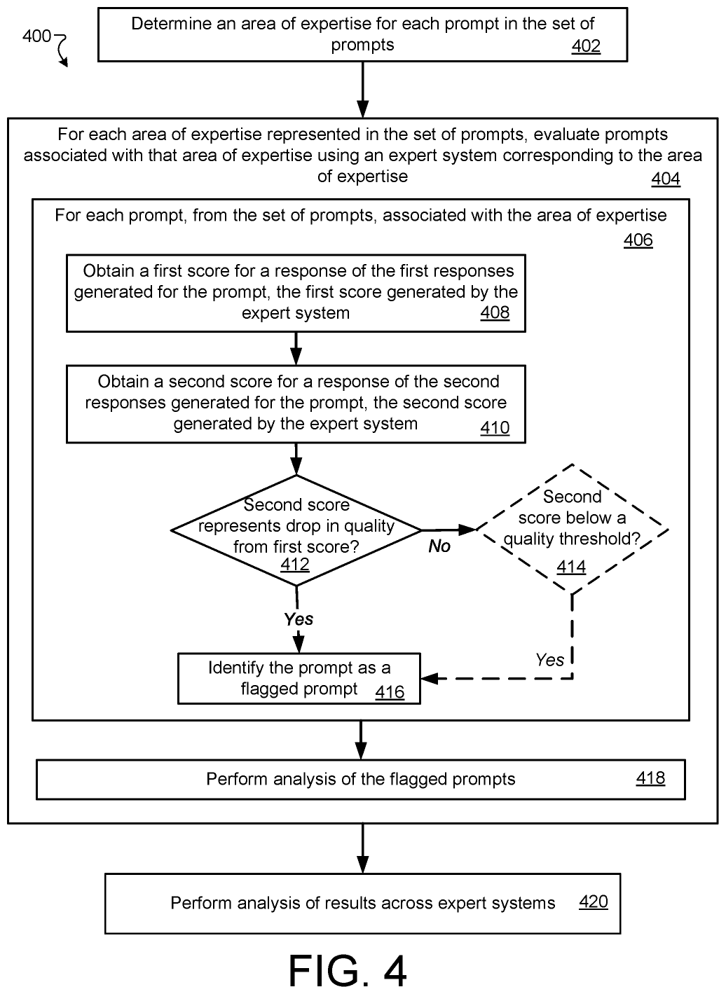

At step 302, the system obtains a set of prompts from a prompt collection. The prompt collection is a data structure stored in a memory. The prompt collection associates prompts with one or more areas of expertise. Each area of expertise corresponds to an expert system. At step 304, the system evaluates first responses generated by a large language model for prompts in the set of prompts. In other words, the first responses are responses generated by a prior version of the model for the prompts in the set of prompts. In some implementations, these first responses may be generated in response to the benchmarking, or in other words as part of the current benchmark testing. In some implementations, these first responses may have been previously generated and evaluated. For example, the evaluation may have occurred as part of a prior benchmark test and the results of the prior benchmark test. In such an implementation, the prompt collection data structure may also include scoring histories. The outcome of the prior evaluation (i.e., the scoring of a response generated by the unmodified large language model) may be stored in the scoring history for a prompt. Accordingly, the evaluation of the first responses may include using scoring histories for prompts in the set of prompts. The system also evaluates second responses generated by a modified version of the large language model for the prompts in the set of prompts. The evaluation of the first responses against the second responses is discussed in more detail with regard to FIG. 4.

At step 306 the system determines whether the evaluation of the first responses against the second responses indicates a degradation criterion is met. In some implementations, the degradation criterion can be an indication that an aggregate score for the second responses represents a predetermined drop in quality from an aggregate score for the first responses. The predetermined drop in quality can be any drop in quality. The predetermined drop in quality can be a percentage of the aggregate score for the first responses. In some implementations, the degradation criterion can be an unacceptable ratio. The unacceptable ratio may represent the number of prompts with second responses that fail to meet a quality threshold compared with the number of prompts in the set. The unacceptable ratio may represent the number of prompts assigned to a first area of expertise with second responses that fail to meet a quality threshold compared with the number of prompts from the set of prompts that are assigned to the first area of expertise. Step 306 may include whether one of two or more degradation criteria is met.

At step 308, in response to the system determining that the evaluation indicates a degradation criterion is met, the system may take remedial action. The remedial action can include preventing the modified version of the large language model from being put into a production environment. The remedial action can include rolling back the modifications, e.g., reverting the model to a prior version that passed a benchmark test. The remedial action can include analysis of the prompts with second responses that represent a drop in quality. For example, the system may cluster the prompts to determine whether there is a topic or prompt format disproportionately affected by the degradation. Such analysis can inform retraining of the model. Remedial action can also include chain of thought/tree of thought approaches, where the model is asked the same questions differently and the expert systems can be used to inform the tree of thought approach. Remedial action can include keeping a version of the previous model running, identifying prompts similar to degraded prompts, and sending those prompts to the previous model. In other words, instead of preventing the rollout of the modified model, the remedial action may be to allow the model to roll out, but divert prompts similar to the degraded prompts to the older version of the model until a future time (e.g., until additional training results in a model that does meet the degradation model. This remedial action can be helpful in meeting a major launch date that is immovable, or in other words in meeting a launch that cannot be postponed but preserving model quality by running a smaller population of prompts to the older version.

At step 310, in response to the system determining that the evaluation indicates a degradation criterion is not met, the system may provide an indication of a successful benchmark. A successful benchmark may allow decreased quality in some prompt responses with offsetting increased quality in other prompt responses. In some implementations, the indication of a successful evaluation can include committing the changes to the modified version of the model. This can include assigning the modified version of the model a version number. In some implementations, several versions may be committed before the model is put into a production environment. In some implementations, at step 310, the system may store the results of the evaluation of the second responses when the benchmark testing is successful. The results of the evaluation may be stored as additional scoring histories in the prompt collection. Thus, after a successful benchmark test, in some implementations the modified model becomes the current model, which may be further modified with additional testing. Method 300 provides an objective way to determine whether modifications to the model affect model quality, a data point not previously available.

FIG. 4 is a diagram that illustrates an example method 400 for using expert systems for benchmarking a modified large language model, according to disclosed implementations. Method 400 may be an example of evaluating the first responses against the second responses as described in step 304 of FIG. 3. At step 402, the system may determine an area of expertise for each prompt in the set of prompts. In some implementations, the prompt may be associated with an area of expertise in a prompt library (prompt collection). In some implementations, the system may include a model that assigns an area of expertise to a prompt, such as a classifier that determines which areas of expertise to assign to the prompt. A prompt may be assigned to more than one area of expertise. Each area of expertise is associated with an expert system. At step 404, for each area of expertise represented in the set of prompts, the system identifies the expert system corresponding to the expertise and uses the expert system to evaluate the second responses (e.g., responses generated by a modified version of a model) against the first responses. Accordingly, step 404 is repeated for each unique area of expertise represented in the set of prompts.

At step 406 the system evaluates the prompt responses to identify flagged prompts. Flagged prompts are prompts where the second response generated for the prompt represents a predetermined drop in quality compared with the first prompt. To determine whether the prompt is a flagged prompt, at step 408 the system obtains a first score for a response of the first responses generated for the prompt. The first responses are responses to prompts that are generated by the large language model before the modification. In some implementations, the system may obtain the first scores from a scoring history of the prompt. In some implementations, the system may obtain the first score by having the large language model (the version before being modified) generate the first response for the prompt and then using the expert system to generate the first score. In some implementations, if a scoring history does not exist for a prompt, the system may obtain the first score by obtaining a response generated by the large language model and then calculate the first score using the expert system.

The first score may represent a veracity score. A veracity score can be provided for responses that include factual statements. A veracity score is an indication of whether the response includes a hallucination. An expert system, such as a knowledge engine, is configured to calculate a veracity score. For example, a knowledge engine is conventionally configured to be used as part of an indexing process for a search engine. As such, the knowledge engine can identify facts in a crawled document and compare those facts against facts in the entity database. The system can provide the first response to the knowledge engine as a document to be indexed, so that the knowledge engine scores the response as it would a crawled document. This can be done without changes to the knowledge engine, i.e., using an existing process of the knowledge engine. The score can be a topicality score. A topicality score represents how well a document (e.g., a response) relates to a query (e.g., a prompt). A knowledge engine conventionally also includes a process for scoring a document that is responsive to a factual query. A factual query is a query that includes an entity and requests information about an entity. The system may use this existing process of a knowledge engine to obtain the score by providing the first response as a document and the prompt as a query. Thus, as with the veracity score, the existing knowledge engine process can be used to parse the prompt and response as a query and candidate responsive document. In some implementations, the first score may represent multiple scores, e.g., both a veracity score and a topicality score. Although described above using a knowledge engine, some implementations can obtain a veracity score by using a search engine or referencing a structured entity page, such as Wikipedia, to determine the veracity score. In some implementations, a veracity score may be obtained from both a knowledge engine and a search engine (or reference to a structured entity page) can be used to obtain two veracity scores. The two scores could be aggregated or could be used separately to determine whether there is a drop in quality.

As another example, the score may be a similarity score. A similarity score is a measure of similarity between the response generated by the large language model for the prompt and a response generated by an expert system for the prompt. For example, a translation engine may be an expert system used to score prompts related to translation requests. A translation engine is configured to provide high quality translations between two specific languages. While a translation engine may use a large language model, the large language model of a translation engine is a specialist model, trained to have high quality in a very narrow area of expertise, which is a much easier problem than having high quality across a broad range of areas. Another example of an expert system that can be used to obtain a similarity score is a math engine. A math engine is configured to provide high quality solutions to mathematical and scientific problems. Any expert system with a specialist model can be used as an expert system from which the system may calculate a similarity score for the first responses. To obtain the similarity score, the system may provide the prompt to the expert system and obtain a response for the prompt. The system may compare the response from the expert system to the first response (the response generated by the large language model). The system may compare the response from the expert system to a portion of the first response. For example, if a prompt is assigned to two areas of expertise, the first response generated for that prompt may include a first portion relevant to the first area of expertise and a second portion relevant to the second area of expertise. Implementations may be able to parse the response to determine the portions.

As another example, the score may be a generated score, obtained from a version of the large language model itself. For example, an older version of the model (including the prior version) or a smaller or larger version of the model may be asked to score some aspect of the response. For example, the model may be asked to give a score between one and ten (or between zero and one, or any other range) representing a level of creativity in the first response, representing whether the first response rhymes (e.g., if the prompt is related to poetry generation), representing the extent to which the first response includes a creative twist, etc. In other words, one of the expert systems may be the model itself and the model may be asked to score the first response.

At step 410 the system obtains a second score for the prompt. The second score is a score for a response from the second responses that was generated for the prompt. In other words, the second score is for a response generated by the modified version of the large language model for the prompt. The second score is obtained using the same expert system (or systems) used to generate the first score for the prompt, only this time the response is a response generated by the modified model. Thus, the first score and the second score for the prompt are directly comparable.

At step 412, the system compares the second score against the first score to determine whether the second score represents a drop in quality from the first score. In some implementations, the drop in quality is absolute. In other words, if the second score is not at least as good as the first score, the system determines there is a drop in quality. In some implementations, a drop in quality can be relative. For example, the system may determine that if the second score is within a predetermined distance of the first score there is no drop in quality. The predetermined distance can be absolute, e.g., within x of the first score. For example, if the first score is 0.85 and the second score is 0.70, x may be a number, such as 0.05, 0.1, 0.15, 0.2, etc. In this example, a drop in quality may be defined as the second score being less than the first score minus the predetermined distance x. The predetermined distance can be proportional, e.g., within y % of the first score. For example, if the first score is 90 a drop in quality may be defined as the second score being less than the first score multiplied by 0.9. These examples are provided for ease of explanation and implementations include other similar ways of defining a drop in quality. In some implementations the drop in quality is dependent on the type of score. For example, the system may use an absolute drop in score for a topicality score and a predetermined distance for a similarity score. If the second score does represent a drop in quality, at step 416 the system may identify the prompt as a flagged prompt. Where the first score (as well as the second score) represents multiple scores (e.g., a veracity and topicality score) each score may be tested for a drop in quality independently. In some implementations, if either score represents a drop in quality the system may identify the prompt as a flagged prompt. In some implementations, the scores may be combined and the combined score may be used to determine whether there is a drop in quality. In some implementations, Thus, the test for a drop in quality is flexible and dependent on the area of expertise, the score type, the number of different scores, etc. Step 406 is repeated for each prompt that is associated with that particular area of expertise.

In some implementations, at step 414 the system may compare the second score to a quality threshold. The quality threshold is independent of the first score. This comparison may help the system identify prompts for which both the first score and the second score are below the quality threshold. While these prompts may not represent a drop in quality (e.g., the second score is not a drop in quality from the first score), these prompts can be identified as flagged prompts (at step 416), although the prompt may be identified as a different flag value so that the system can differentiate between flagged prompts that represent a drop in quality from the first score (step 412, yes) from flagged prompts that have responses of low quality (e.g., scored below the quality threshold, step 414, yes).

At step 418, the system may perform an analysis (evaluation) using the flagged prompts. The analysis can determine an overall or aggregate score for the model (i.e., a first score for the original, unmodified model and a second score for the modified model) from the point of view of that area of expertise. Because a benchmark test can allow some degree of degradation, the aggregated score can tolerate some amount of backsliding. For example, the system may determine a ratio of the number of flagged prompts to the number of prompts for that area of expertise. This ratio can be compared to a predetermined ratio that represents an unacceptable ratio. If the ratio is less than the unacceptable ratio (e.g., there are fewer flagged prompts) then the evaluation may be considered successful. Put another way, the degradation criterion may be whether the ratio is less than the unacceptable ratio. If the ratio is greater to the unacceptable ratio, then the system may determine that the evaluation meets the degradation criterion.

In some implementations, step 418 may include additional analysis. The additional analysis may provide guidance on what kinds of prompts represent a drop in quality, what kinds of prompts represent low quality prompts that did not improve (e.g., the second score is below a quality threshold). In some implementations, the analysis of step 418 can perform analysis on all the prompts in the set of prompts for that area of expertise. This may provide insight into what kinds of prompts maintained quality or increased quality. The analysis can include techniques that identify a shared characteristic of flagged prompts. For example, clustering techniques may be used to identify a shared characteristic of the flagged prompts. Clustering techniques may also be used to identify a shared characteristic of prompts where the response did not improve (e.g., was flagged in response to step 414). The shared characteristic can be a topic shared by the prompts. The shared characteristic can be a query type shared by the prompts. The query type can represent the area of expertise. In some implementations, the result of the analysis may be presented in a dashboard, either as part of step 418 or step 420. The dashboard may provide a summary of the analysis. The dashboard can provide various data items generated for the analysis, e.g., the number of flagged prompts, shared characteristics of the prompts, the ratio, details on flagged prompts, etc. In some implementations the dashboard may include a selectable control that enables a user to identify the result of the evaluation. For example, the selectable control may enable a user to identify the evaluation as failing a degradation criterion (e.g., unsuccessful) or as meeting a degradation criteria (i.e., as successful). In some implementations, this control may override a programmatically determined outcome of the evaluation. Thus, for example, an operator may override a determination by the system that the evaluation is successful.

After all areas of expertise have been evaluated, at step 420 the system may perform an analysis across all expert systems. In this analysis, the system may determine whether the analysis of any areas of expertise is unsuccessful (indicates a degradation criterion is met) and, if so, determine that the overall benchmark is unsuccessful. In addition, in some implementations, the system may perform analysis across all flagged prompts, which may enable the system to identify additional shared characteristics not previously identified. In some implementations, shared characteristic analysis is only performed at step 420. In some implementations, shared characteristic analysis is only performed at step 418. As indicated above, step 420 may include display of a dashboard as discussed above. Method 400 ends with a determination of whether the evaluation of the responses generated by the modified language model meet a degradation criterion. As indicated above, this determination can be arrived at programmatically, without operator intervention, can be arrived at with operator input, or can be provided by the operator (e.g., overriding any programmatic conclusion).

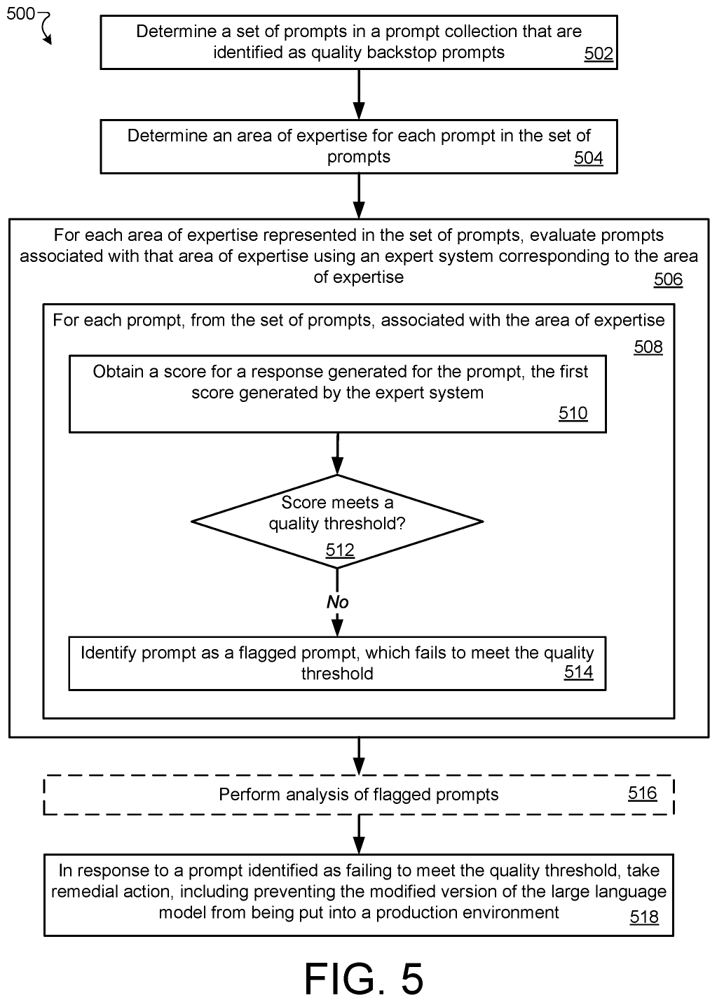

FIG. 5 is a diagram that illustrates an example method 500 for using expert systems for high-water marking a modified large language model, according to disclosed implementations. Method 500 may be executed in an environment, such as environment 100 of FIG. 1. The method 500 enables evaluation of the modified model against a prior version of the model, e.g., a version running in a production environment, a version that passed previous benchmarks but has not yet been put into production, etc. The prior version of the model is considered a current version, or an original version, or an unmodified version. The modified version of the model may represent additional training/fine-tuning performed on the prior model. In some implementations, the method steps may be executed by a system, such as model evaluation system 140. In some implementations, the method steps may be executed by a system that includes the model evaluation system 140 and one or more expert systems 150. In some implementations, the method steps may be executed by a system that includes the model evaluation system 140, one or more expert systems 150, and the generative AI system 130′ of FIG. 1. In some implementations, the method steps may be executed by a system that includes the model evaluation system 140, one or more expert systems 150, the generative AI system 130 and/or the generative AI system 130′ of FIG. 1. Method 500 provides another objective way to determine whether modifications to the model affect model quality.

At step 502, the system obtains a set of prompts from a prompt collection that are identified as quality backstop prompts. The prompt collection is described in more detail above. In implementations that support high-water mark testing, the prompt collection includes a set of prompts used in the high-water mark testing. This set of prompts may be smaller than the set of prompts used for benchmarking. Thus, high-water testing may execute more quickly than benchmark testing. A quality backstop prompt is a prompt for which the modified large language model must generate an acceptable response, e.g., as measured against a quality threshold. As with benchmark testing, high-water mark testing uses the expert systems to obtain a score for the responses generated by the modified language model and compares the score to the appropriate quality threshold. Such prompts may be curated by operators of the system. Such prompts may represent prompts in sensitive or important areas. Such prompts may represent prompts that have demonstrated historical stability. For example, responses for the prompt “what is the birthplace of queen Elizabeth” may have historically been scored above the quality threshold, meaning that the response is stable. Because this fact does not change over time, the response also should not change and the score of the response should stay above the quality threshold.

At step 504, the system may determine an area of expertise for each prompt in the set of prompts. This determination is similar to the determination discussed above with respect to step 402 of FIG. 4. At step 506, for each area of expertise represented in the set of prompts, the system identifies the expert system corresponding to the expertise and uses the expert system to evaluate responses generated by a modified version of a large language model. Accordingly, step 504 is repeated for each unique area of expertise represented in the set of prompts.

At step 508 the system obtains and evaluates responses to the prompts to identify flagged prompts. Flagged prompts are prompts where the response generated for the prompt by the modified model fails to meet a quality threshold. To determine whether the prompt is a flagged prompt, at step 510 the system obtains a response for the prompt from the modified model and calculates a quality score for the response using the expert system. The quality score can be one or more of the scores discussed above with regard to FIG. 4.

At step 512 the system determines whether the quality score meets a quality threshold. The quality threshold can be determined by the type of score being compared to the quality threshold and/or determined based on the expert system used to generate the score. As explained with respect to FIG. 4, the system may combine two or more scores or may compare two scores generated for a response individually. If the score fails to meet the quality threshold, at step 514 the system may identify the prompt as a flagged prompt. In method 500, any flagged prompt represents a prompt for which the modified model did not generate a response of adequate quality. Step 508 is repeated for each quality backstop prompt corresponding to the area of expertise.

In some implementations, at step 516, the system may perform an analysis (evaluation) of the flagged prompts. Similar to the analysis described in step 418, the analysis can include identifying shared characteristics of flagged prompts. Step 516 may also include generation and display of a dashboard. The dashboard may list the details of the flagged prompt and the response generated for the response. In some implementations, the dashboard may include a selectable control that enables a user to override a flagged prompt.

At step 518, in response to the system determining that a flagged prompt exists, i.e., that at least one prompt has a response generated by the modified model that fails to meet a quality threshold, the system may take remedial action. The remedial action can include preventing the modified version of the large language model from being put into a production environment. The remedial action can include rolling back the modifications, e.g., reverting the model to a prior version. The remedial action can include changing the quality threshold, e.g., if it is decided that the threshold is too sensitive. The remedial action can include further training and/or chain of thought/tree of thought approaches, as described with regard to FIG. 3. Remedial action can include keeping a version of the previous model running, identifying prompts similar to the quality backstop prompts that failed to meet the quality threshold, and sending those prompts to the previous model. In other words, instead of preventing the rollout of the modified model, the remedial action may be to allow the modified version of the model to roll out, but to divert prompts similar to the flagged prompts to the older version of the model until a future time (e.g., until additional training results in a model that generates a response that meets the quality threshold.

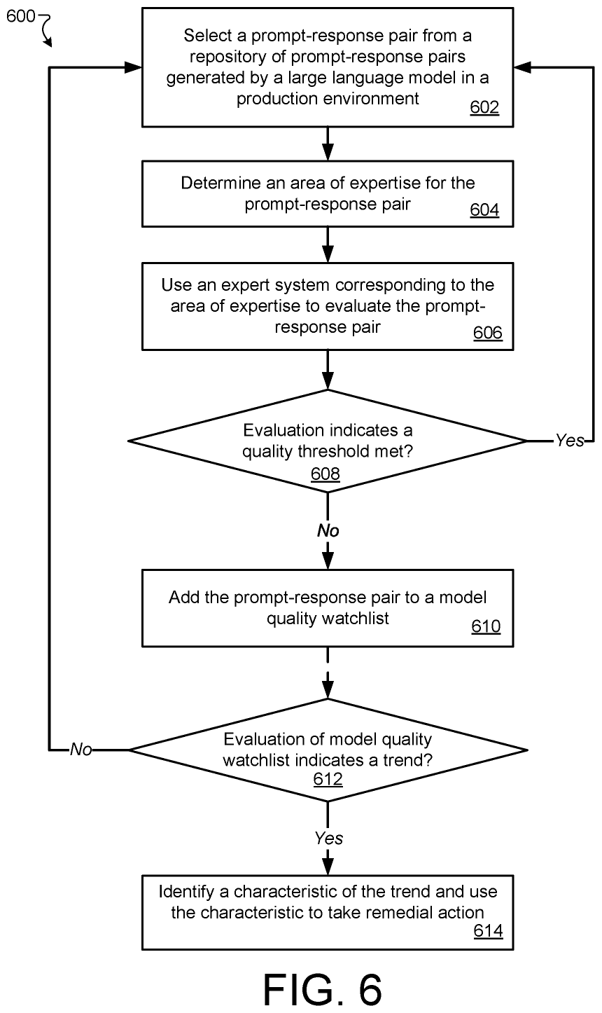

FIG. 6 is a diagram that illustrates an example method 600 for identifying low-quality trends produced by a large language model, according to disclosed implementations. The method 600 may be executed in an environment, such as environment 100. In some implementations, one or more of the method steps may be executed by a system, which can include model evaluation system 140, generative AI system 130, and/or expert systems 150 of FIG. 1. Method 600 may be performed periodically, e.g., every minute, every hour, every two hours etc. At step 602, the system selects a prompt-response pair from a repository of prompt-response pairs. The repository of prompt-response pairs is generated by a large language model. The large language model may be running in a production environment. An example of a repository of prompt-response pairs is the model log 270 of FIG. 1. The selection can be random. The selection can be a selection from prompt-response pairs during a window of time. The window of time may represent a period of time since the last execution of method 600. The period of time may represent a predetermined window (e.g., last 6 hours, last five minutes, etc.) The period of time may not be tied to the last execution of method 600. The selection can be based on the prompt-response pair being identified by the user as unsatisfactory. This unsatisfactory indication may be stored as an attribute of the prompt-response pair in the repository.

At step 604, the system may determine an area of expertise for the prompt-response pair. In some implementations, the system may include a process that assigns an area of expertise to a prompt, such as a process that uses a classifier or logic to determine which area of expertise the prompt belongs to. A prompt may belong to more than one area of expertise. Each area of expertise is associated with an expert system. At step 606, the system evaluates the prompt-response pair using the expert system associated with the area of expertise for the prompt. This evaluation is performed in a manner similar to that explained above with respect to step 508 of FIG. 5. In other words, the system obtains a score for the response of the prompt-response pair using the expert system.

At step 608, the system determines whether the evaluation indicates that a quality threshold is met. The evaluation may include comparing the score against a quality threshold. In some implementations, if the score meets a quality threshold, the system may select and evaluate another prompt (e.g., returning to step 602) until a predetermined number of prompt-response pairs have been selected and analyzed. In some implementations, if the score meets a quality threshold, method 600 may end. If the evaluation indicates that the quality threshold is not met, at step 610 the system may add the prompt-response pair to a model quality watchlist. The model quality watchlist represents a data store of prompt-response pairs that the model evaluation system 140 can analyze to identify trends in responses of poor quality. Model quality watchlist 254 of FIG. 2 is an example model quality watchlist.

At step 612, the system may analyze the model quality watchlist to determine whether a trend exists. In one example, the system may determine that a trend exists by determining that a predetermined number of prompt-response pairs sharing a characteristic exist in the model quality watchlist. This characteristic can be a topic, a query format, etc. As discussed with respect to FIG. 2, older prompt-response pairs may be excluded from the evaluation. This can occur expressly (e.g., the evaluation only considers prompt-response pairs within a certain timeframe, such as a week, two weeks, etc.), because of a time decay that counts older prompt-response pairs as less than a full pair, and/or because prompt-response pairs are removed from the watchlist. Step 612 can be run asynchronously with steps 602 to 610. In other words, step 612 can be run any time after records have been added to the model quality watchlist and need not be in response to a prompt-response pair being added to the watchlist.

If the system identifies a trend, at step 614 the system may identify a characteristic of the trend and use that characteristic to take remedial action. The remedial action may be to notify an operator of the characteristic. This enables the operator to set up training of the large language model to address the lower quality for that characteristic. Method 600 enables the system to proactively identify areas where the large language model may benefit from additional training, which improves the overall model quality.

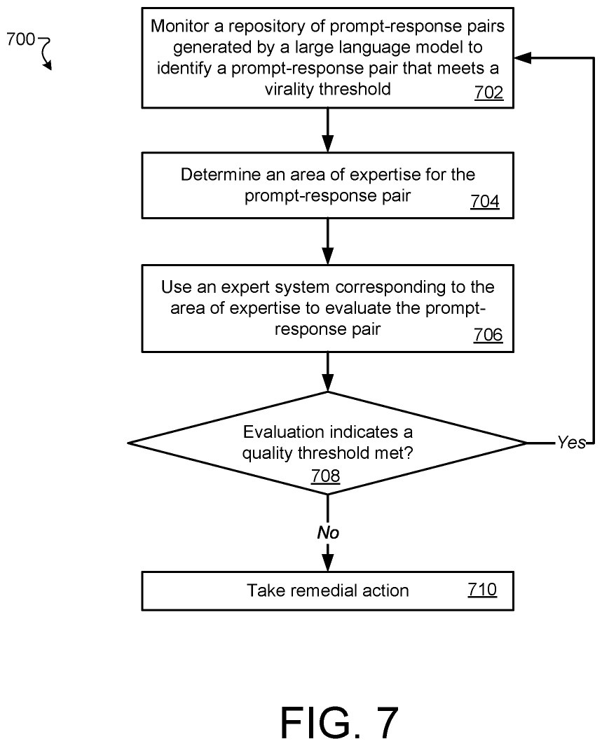

FIG. 7 is a diagram that illustrates an example method 700 for identifying viral low-quality responses produced by a large language model, according to disclosed implementations. The method 700 may be executed in an environment, such as environment 100. In some implementations, one or more of the method steps may be executed by a system, which may include one or more of model evaluation system 140, generative AI system 130, and/or expert systems 150 of FIG. 1. Method 700 enables the system to proactively (e.g., automatically and without operator intervention) identify prompts that result in responses of low quality. Because these responses are of low quality, they may represent especially problematic/undesirable responses. Such responses may cause undesired attention for the large language model distrust of the model responses. Prompts that represent an unexpected spike (e.g., receiving many requests for the same prompt in a short period of time) are referred to as viral prompts and can be an indication of low quality responses. Method 700 may be used to identify and address virality.

At step 702, the system monitors a repository of prompt-response pairs to identify a prompt-response pair that meets a virality threshold. The virality threshold may represent a predetermined number of similar prompts received in a defined window of time. The virality threshold may represent an unexpected increase in the number of times a prompt is received during a window of time compared with a prior window of time. For example, a particular prompt received five times in the prior hour but 50 times in the current hour may meet the virality threshold. The monitoring may cluster similar prompts together, so prompts do not need to be exact copies of each other. This enables the system to be more accurate on the number of times a prompt (similar prompt) is received during any particular window of time.

If a prompt-response pair is determined to meet a virality threshold, at step 704 the system determines an area of expertise for the prompt-response pair. At step 706 the system uses an expert system to evaluate the response of the prompt-response pair. This evaluation is similar to the evaluations discussed above and can include generating a score or scores for the response and comparing that score or scores to a quality threshold (e.g., at step 708). If a response fails to meet the quality threshold, at step 710 the system may take remedial action. This may include reporting the prompt-response pair to an operator. This may include preventing the model from generating a response to similar prompts, i.e., to preserve model quality and trust in the model.

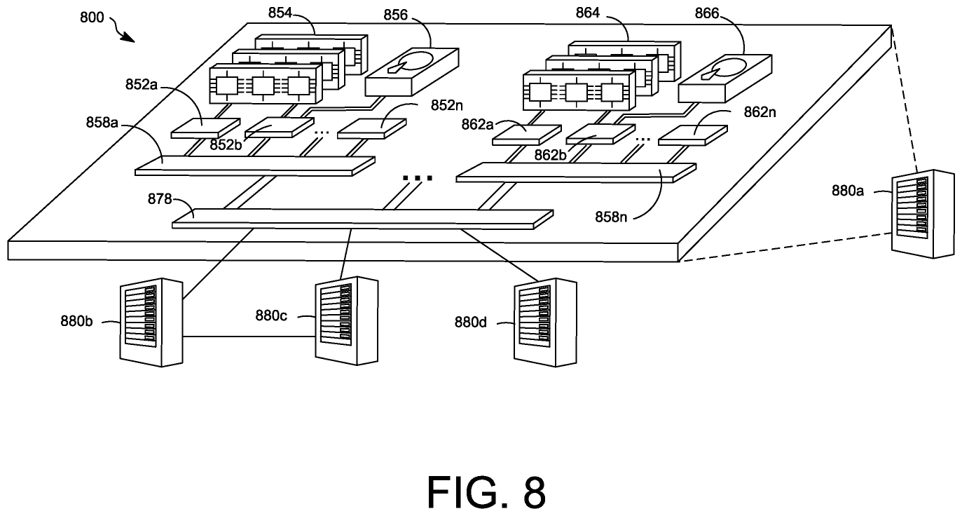

FIG. 8 shows an example of a computing device 800, which may be search system 120, the generative AI system 130, and/or the expert system 150 of FIG. 1, which may be used with the techniques described here. Computing device 800 is intended to represent various example forms of large-scale data processing devices, such as servers, blade servers, data centers, mainframes, and other large-scale computing devices. Computing device 800 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Computing device 800 may be a distributed system that includes any number of computing devices 880 (e.g., 880a, 880b, . . . 880n). Computing devices 880 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 880a includes multiple racks 858a-858n. Each rack may include one or more processors, such as processors 852a-852n and 862a-862n. The processors may include data processors, network attached storage devices, and other computer-controlled devices. In some implementations, one processor may operate as a master processor and control the scheduling and data distribution tasks. Processors may be interconnected through one or more rack switches 862a-862n, and one or more racks may be connected through switch 878. Switch 878 may handle communications between multiple connected computing devices 800.

Each rack may include memory, such as memory 854 and memory 864, and storage, such as 856 and 866. Storage 856 and 866 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 856 or 866 may be shared between multiple processors, multiple racks, or multiple computing devices and may include a non-transitory computer-readable medium storing instructions executable by one or more of the processors. Memory 854 and 864 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 854 may also be shared between processors 852a-852n. Data structures, such as an index, may be stored, for example, across storage 856 and memory 854. Computing device 800 may include other components not shown, such as controllers, buses, input/output devices, communications modules, etc.

An entire system may be made up of multiple computing devices 800 communicating with each other. For example, device 880a may communicate with devices 880b, 880c, and 880d, and these may collectively be known as generative AI system 130, expert system 150, and/or search system 120. Some of the computing devices may be located geographically close to each other, and others may be located geographically distant. The layout of computing device 800 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Clause 1. A system, comprising: a processor; a prompt library, the prompt library associating prompts with areas of expertise, each prompt being associated with at least one area of expertise and, for the at least one area of expertise, a respective score; and memory storing instructions that, when executed by the processor, cause the system to: evaluate first responses generated by a large language model to a set of prompts selected from the prompt library using expert systems associated with the areas of expertise for the set of prompts against second responses generated by a modified version of the large language model to the set of prompts, determine that the evaluation indicates a degradation criterion is met, and initiating remedial action in response to determining that the evaluation indicates a degradation criterion is met.

Clause 2. The system as in clause 1, wherein evaluating the first responses against the second responses includes, for each prompt in the set of prompts that is associated with a first area of expertise: obtaining, from an expert system that corresponds to the first area of expertise, a first score for a response of the first responses generated for the prompt; obtaining, from the expert system, a second score for a response, of the second responses, generated for the prompt; and identifying the prompt as a flagged prompt in response to determining that the second score represents a predetermined drop in quality from the first score.

Clause 3. The system as in clause 2, wherein the prompt library stores the first score for the response, wherein obtaining the first score for the response includes obtaining the first score from the prompt library.

Clause 4. The system as in clause 2, wherein the memory further stores instructions that cause the system to store the second score for the prompt in the prompt library.

Clause 5. The system as in clause 2, wherein evaluating the first responses against the second responses further includes: analyzing the flagged prompts for a shared characteristic; and providing an output of the analyzing, including identifying the shared characteristic.

Clause 6. The system as in clause 5, wherein the shared characteristic is a topic or query type shared by the flagged prompts.

Clause 7. The system as in clause 6, wherein the degradation criterion represents an unacceptable ratio of flagged prompts with the shared characteristic of the flagged prompts.

Clause 8. The system of clause 5, wherein the analyzing includes clustering the flagged prompts.

Clause 9. The system as in clause 2, wherein evaluating the first responses against the second responses further includes: determining a ratio of flagged prompts to prompts in the set of prompts that are associated with the first area of expertise, wherein the degradation criterion represents an unacceptable ratio.

Clause 10. The system as in clause 2, wherein the expert system is a first expert system and evaluating the first responses against the second responses includes: for each prompt in the set of prompts that is associated with a second area of expertise: obtain, from a second expert system that corresponds to the second area of expertise, a third score for a response, of the first responses, generated for the prompt, obtain, from the second expert system, a fourth score for a response, of the second responses, generated for the prompt, and identifying the prompt as a flagged prompt in response to determining that the fourth score represents a predetermined drop in quality from the second score; and determining a ratio of a quantity of flagged prompts to a quantity of prompts in the set of prompts that are associated with the first area of expertise or the second area of expertise, wherein the degradation criterion represents an unacceptable ratio.

Clause 11. The system as in clause 10, wherein determining the ratio further includes: determining a first ratio of flagged prompts for prompts associated with the first area of expertise to prompts in the set of prompts that are associated with the first area of expertise; and determining a second ratio of flagged prompts for prompts associated with the second area of expertise to prompts in the set of prompts that are associated with the second area of expertise, wherein the degradation criterion represents an unacceptable first ratio or an unacceptable second ratio.

Clause 12. The system as in clause 1, wherein at least some of the prompts in the prompt library are identified as a quality backstop prompt and the set of prompts includes prompts identified as quality backstop prompts and the degradation criterion includes failure of a score for a second response generated for a prompt identified as a quality backstop prompt to at least meet a score for a first response generated for the prompt.

Clause 13. The system as in clause 1, the memory further storing instructions that cause the system to: randomly select a prompt-response pair generated by the large language model for evaluation; obtain a quality score by evaluating the prompt-response pair using an expert system of the expert systems; determine that the quality score fails to meet a quality threshold; determine that the prompt-response pair constitute a trend; and identify the trend as an area for further training the large language model.

Clause 14. The system as in clause 1, the memory further storing instructions that cause the system to: identify a prompt-response pair, generated by the large language model in a production environment, that meets a virality threshold; obtain a quality score for the prompt-response pair using an expert system of the expert systems; and initiate remedial action for the prompt-response pair in response to determining that the quality score fails to meet a quality threshold.

Clause 15. The system as in clause 14, wherein the remedial action includes preventing the large language model from generating a response to a prompt of the prompt-response pair in the production environment.

Clause 16. The system as in clause 14, wherein the remedial action includes providing the prompt-response pair for operator review.

Clause 17. The system as in clause 1, wherein the expert systems include a knowledge engine, wherein the knowledge engine scores a response generated for a prompt as a candidate responsive document to a query represented by the prompt.

Clause 18. The system as in clause 1, wherein the remedial action prevents the modified version of the large language model from being put into a production environment.

Clause 19. The system as in clause 1, wherein the remedial action includes rolling the modified version of the large language model to a production environment and diverting, in the production environment, prompts similar to prompts in the set of prompts that contributed to meeting the degradation criterion to the large language model instead of to the modified version of the large language model.

Clause 20. A method comprising: identifying a prompt submitted to a large language model that meets a virality threshold; obtaining a quality score for a prompt-response pair representing the prompt using an expert system; and initiating remedial action for the prompt in response to determining that the quality score fails to meet a quality threshold.

Clause 21. The method as in clause 20, wherein the remedial action includes preventing the large language model from generating a response to the prompt in a production environment.

Clause 22. The method as in clause 20, wherein identifying the prompt as meeting the virality threshold includes: determining that the prompt is a member of a cluster of prompts that has at least a predetermined number of members submitted during a defined window of time.

Clause 23. The method as in clause 22, wherein the defined window of time is a first window and the predetermined number is defined in relation to a quantity of members of the cluster submitted during a second window of time occurring prior to the first window.

Clause 24. The method as in clause 20, wherein the prompt is a first prompt and the method further includes: randomly selecting a second prompt and response submitted to the large language model for evaluation; obtaining a second quality score by evaluating the second prompt and response using the expert system; determining that the second quality score fails to meet the quality threshold; determining that the second prompt and response constitute a trend; and identifying the trend as an area for further training the large language model.

Clause 25. A method comprising: using at least a first expert system to evaluate first responses, generated by a large language model in response to prompts in a set of prompts selected from a prompt collection, against second responses generated by a modified version of the large language model in response to the prompts in the set of prompts, the evaluation including for each prompt in the set of prompts: obtaining a first score for a response, of the first responses, generated for the prompt, obtaining a second score for a response, of the second responses, generated for the prompt, and identifying the prompt as a flagged prompt in response to determining that the second score represents a predetermined drop in quality from the first score; determining a ratio of flagged prompts to prompts in the set of prompts; determining that the ratio represents an unacceptable ratio; and preventing the modified version of the large language model from being put into a production environment.

Clause 26. The method as in clause 25, wherein the prompt collection stores the first score for the response and obtaining the first score for the response includes obtaining the first score from the prompt collection.

Clause 27. The method as in clause 25, further comprising storing the second score for the prompt in the prompt collection.

Clause 28. The method as in clause 25, wherein the first expert system includes a knowledge engine, wherein the knowledge engine scores a response generated for a prompt as a candidate responsive document to a query represented by the prompt.

Clause 29. The method as in clause 25, wherein the first expert system includes a math engine, wherein the math engine scores a response generated for a prompt for similarity against a prompt generated by a math engine.

Clause 30. The method as in clause 25, wherein evaluating the first responses against the second responses further includes: analyzing the prompts for a shared characteristic; and providing an output of the analyzing, including identifying the shared characteristic.

Clause 31. The method as in clause 30, wherein the shared characteristic is a topic or query type shared by the flagged prompts and the unacceptable ratio represents a ratio of flagged prompts with the shared characteristic to prompts in the set of prompts having the shared characteristic.

Clause 32. A method comprising: selecting, from a prompt collection, a set of prompts identified as quality backstop prompts; using at least a first expert system to evaluate responses, generated by a modified version of a large language model to prompts in the set of prompts; determining that at least one response fails to meet a quality threshold; and preventing the modified version of the large language model from being put into a production environment.

Clause 33. The method as in clause 32, wherein the prompts in the set of prompts are identified in the prompt collection as quality backstop prompts for an area of expertise of the first expert system.

Clause 34. The method as in clause 33, further comprising using a second expert system to evaluate responses generated by the modified version of the large language model to prompts associated with a second area of expertise, the second expert system corresponding to the second area of expertise.

Clause 35. The method as in clause 32, wherein using the first expert system to evaluate a response generated for a prompt in the set of prompts includes obtaining a score for the response using the first expert system.

Clause 36. The method as in clause 35, wherein the first expert system is a knowledge engine and the score represents at least one of a topicality score for the response or a veracity score for the response.

Clause 37. A method comprising: selecting a prompt-response pair from a prompt-response repository, prompt-response pairs in the prompt-response repository being generated by a large language model in a production environment; obtaining a score for the prompt-response pair using an expert system; determining that the score fails to meet a quality threshold; and in response to determining that the score fails to meet the quality threshold, storing the prompt-response pair in a quality watchlist, the quality watchlist being used to identify trends related to model quality.

Clause 38. The method as in clause 37, wherein the prompt-response pair is randomly selected from the prompt-response repository from prompt-response pairs stored within a window of time.

Clause 39. The method as in clause 37, further comprising: determining a trend by analyzing prompts in the quality watchlist; and initiating a remedial action in response to determining the trend.

Clause 40. The method as in clause 39, wherein determining the trend includes: clustering the prompts into topic clusters; and determining that a cluster of the topic clusters has at least a predetermined number of members, wherein initiating the remedial action includes initiating further training of the large language model based on the prompts in the cluster or preventing the large language model from generating responses to prompts that are similar to prompts in the cluster.

What is claimed is:

1. A system, comprising:
a processor;
a prompt library, the prompt library associating prompts with areas of expertise, each prompt being associated with at least one area of expertise and, for the at least one area of expertise, a respective score; and
memory storing instructions that, when executed by the processor, cause the system to:
evaluate first responses generated by a large language model to a set of prompts selected from the prompt library using expert systems associated with the areas of expertise for the set of prompts against second responses generated by a modified version of the large language model to the set of prompts,
determine that the evaluation indicates a degradation criterion is met, and
initiating remedial action in response to determining that the evaluation indicates a degradation criterion is met.

2. The system as in claim 1, wherein evaluating the first responses against the second responses includes, for each prompt in the set of prompts that is associated with a first area of expertise:
obtaining, from an expert system that corresponds to the first area of expertise, a first score for a response of the first responses generated for the prompt;
obtaining, from the expert system, a second score for a response, of the second responses, generated for the prompt; and
identifying the prompt as a flagged prompt in response to determining that the second score represents a predetermined drop in quality from the first score.

3. The system as in claim 2, wherein the prompt library stores the first score for the response, wherein obtaining the first score for the response includes obtaining the first score from the prompt library.

4. The system as in claim 2, wherein the memory further stores instructions that cause the system to store the second score for the prompt in the prompt library.

5. The system as in claim 2, wherein evaluating the first responses against the second responses further includes:
analyzing the flagged prompts for a shared characteristic; and
providing an output of the analyzing, including identifying the shared characteristic.

6. The system as in claim 5, wherein the shared characteristic is a topic or query type shared by the flagged prompts and the degradation criterion represents an unacceptable ratio of flagged prompts with the shared characteristic of the flagged prompts.

7. The system as in claim 2, wherein evaluating the first responses against the second responses further includes:
determining a ratio of flagged prompts to prompts in the set of prompts that are associated with the first area of expertise,
wherein the degradation criterion represents an unacceptable ratio.

8. The system as in claim 2, wherein the expert system is a first expert system and evaluating the first responses against the second responses includes:
for each prompt in the set of prompts that is associated with a second area of expertise:
obtain, from a second expert system that corresponds to the second area of expertise, a third score for a response, of the first responses, generated for the prompt,
obtain, from the second expert system, a fourth score for a response, of the second responses, generated for the prompt, and
identifying the prompt as a flagged prompt in response to determining that the fourth score represents a predetermined drop in quality from the second score; and
determining a ratio of a quantity of flagged prompts to a quantity of prompts in the set of prompts that are associated with the first area of expertise or the second area of expertise,
wherein the degradation criterion represents an unacceptable ratio.

9. The system as in claim 8, wherein determining the ratio further includes:
determining a first ratio of flagged prompts for prompts associated with the first area of expertise to prompts in the set of prompts that are associated with the first area of expertise; and
determining a second ratio of flagged prompts for prompts associated with the second area of expertise to prompts in the set of prompts that are associated with the second area of expertise,
wherein the degradation criterion represents an unacceptable first ratio or an unacceptable second ratio.

10. The system as in claim 1, wherein at least some of the prompts in the prompt library are identified as a quality backstop prompt and the set of prompts includes prompts identified as quality backstop prompts and the degradation criterion includes failure of a score for a second response generated for a prompt identified as a quality backstop prompt to at least meet a score for a first response generated for the prompt.

11. The system as in claim 1, wherein the expert systems include a knowledge engine, wherein the knowledge engine scores a response generated for a prompt as a candidate responsive document to a query represented by the prompt.

12. The system as in claim 1, wherein the remedial action prevents the modified version of the large language model from being put into a production environment.

13. The system as in claim 1, wherein the remedial action includes rolling the modified version of the large language model to a production environment and diverting, in the production environment, prompts similar to prompts in the set of prompts that contributed to meeting the degradation criterion to the large language model instead of to the modified version of the large language model.

14. A method comprising:
using at least a first expert system to evaluate first responses, generated by a large language model in response to prompts in a set of prompts selected from a prompt collection, against second responses generated by a modified version of the large language model in response to the prompts in the set of prompts, the evaluation including for each prompt in the set of prompts:
obtaining a first score for a response, of the first responses, generated for the prompt,
obtaining a second score for a response, of the second responses, generated for the prompt, and
identifying the prompt as a flagged prompt in response to determining that the second score represents a predetermined drop in quality from the first score;
determining a ratio of flagged prompts to prompts in the set of prompts;
determining that the ratio represents an unacceptable ratio; and
preventing the modified version of the large language model from being put into a production environment.

15. The method as in claim 14, wherein the prompt collection stores the first score for the response and obtaining the first score for the response includes obtaining the first score from the prompt collection.

16. The method as in claim 14, further comprising storing the second score for the prompt in the prompt collection.

17. The method as in claim 14, wherein the first expert system includes a knowledge engine, wherein the knowledge engine scores a response generated for a prompt as a candidate responsive document to a query represented by the prompt.

18. The method as in claim 14, wherein the first expert system includes a math engine, wherein the math engine scores a response generated for a prompt for similarity against a prompt generated by a math engine.

19. The method as in claim 14, wherein evaluating the first responses against the second responses further includes:
analyzing the prompts for a shared characteristic; and
providing an output of the analyzing, including identifying the shared characteristic.

20. The method as in claim 19, wherein the shared characteristic is a topic or query type shared by the flagged prompts and the unacceptable ratio represents a ratio of flagged prompts with the shared characteristic to prompts in the set of prompts having the shared characteristic.

21. A method comprising:
selecting, from a prompt collection, a set of prompts identified as quality backstop prompts;
using at least a first expert system to evaluate responses, generated by a modified version of a large language model to prompts in the set of prompts;
determining that at least one response fails to meet a quality threshold; and
preventing the modified version of the large language model from being put into a production environment.

22. The method as in claim 21, wherein the prompts in the set of prompts are identified in the prompt collection as quality backstop prompts for an area of expertise of the first expert system.

23. The method as in claim 22, further comprising using a second expert system to evaluate responses generated by the modified version of the large language model to prompts associated with a second area of expertise, the second expert system corresponding to the second area of expertise.

24. The method as in claim 21, wherein using the first expert system to evaluate a response generated for a prompt in the set of prompts includes obtaining a score for the response using the first expert system.

25. The method as in claim 24, wherein the first expert system is a knowledge engine and the score represents at least one of a topicality score for the response or a veracity score for the response.
